(19) United States
(12) Patent Application Publication
(10) Pub. No.: US 2026/0306999 A1
(43) Pub. Date: Oct. 8, 2026

(54) PROCESS AND APPARATUS FOR SEPARATING CARBON DIOXIDE FROM A FLUE GAS STREAM

(71) Applicant: L'Air Liquide, Societe Anonyme pour l'Etude et l’Exploitation des Procedes Georges Claude, Paris (FR)

(72) Inventors: Alexander HAENEL; Dieter ULBER; Mirko HUEBEL

(21) Appl. No.: 19/480,571

(22) PCT Filed: May 6, 2024
(86) PCT No.: PCT/EP2024/062482

§ 371 Date: Oct. 31, 2025

(30) Foreign Application Priority Data
May 23, 2023 (EP) 23174846.8

(51) Int. Cl. B01D 53/14; B01D 53/18; F23J 15/04

(52) U.S. Cl. CPC B01D 53/1475; B01D 53/1412; B01D 53/1481; B01D 53/18; F23J 15/04; B01D 2257/302; B01D 2257/504; B01D 2258/0283

(57) ABSTRACT

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

### CROSS REFERENCE TO RELATED APPLICATIONS

This application is a 371 of International Application No. PCT/EP2024/062482, filed May 6, 2024, which claims priority to European Patent Application No. 23174846.8, filed May 23, 2023, the entire contents of which are incorporated herein by reference.

### BACKGROUND

### Field of the Invention

The invention relates to a process for separating carbon dioxide from a flue gas stream. The invention especially relates to such a process with improved control. The invention further relates to an apparatus for separating carbon dioxide from a flue gas stream. The invention especially relates to such an apparatus with improved control.

### Prior Art

Post-published European patent application EP22161775 discloses in one embodiment a process for separating carbon dioxide from a flue gas stream in which a flue gas chimney is openly integrated in the flue gas channel between a flue gas-generating unit and a carbon dioxide separation unit. In the present case “openly integrated” is to be understood as meaning that the overall system is always open to the atmosphere via the upper outlet of the flue gas chimney.

Such “open integration” has the advantage that it is particularly easy to implement for retrospective modification of existing industrial plants if a corresponding plant is to be retrospectively provided with carbon dioxide separation for treatment of flue gases. Integration of a carbon dioxide separation unit via a branch upstream of the flue gas chimney is often infeasible for reasons of space.

However, open integration is associated with challenges in terms of controlling the pressure in the flue gas-generating unit. The pressure in the flue gas-generating unit and in the flue gas channels must also be adjusted such that in normal operation when the carbon dioxide separation unit is active only minimal amounts of flue gas, if any, escape through the flue gas chimney into the atmosphere.

Control of the pressure in the flue gas-generating unit is carried out for example via the speed of a blower arranged within the flue gas channel which effects withdrawal of the flue gases from the flue gas-generating unit and, by increasing the pressure in the flue gas channel, conveyance thereof to the carbon dioxide separation unit. In order to ensure the latter a further blower may be arranged downstream of the flue gas chimney within the flue gas channel.

In the event of malfunctions, for example in the event of a sudden shutdown of the carbon dioxide separation unit, the flue gas must be immediately diverted into the flue gas chimney in larger quantities. This alters the flow and pressure conditions downstream and then upstream of the flue gas blower.

The pressure in the flue gas-generating unit thus begins to deviate from its setpoint and can therefore rapidly achieve a high or low pressure actuation setpoint. Reaching such an actuation setpoint may cause the flue gas-generating unit to shut down. If this unit is a steam reformer for example, production of synthesis gas is terminated. Such a scenario resulting from a malfunction in the carbon dioxide separation unit is undesirable and therefore to be avoided.

Measurement of the pressure conditions in the flue gas system and alteration thereof as an input signal is not optimal for being able to react quickly enough to problems of the abovementioned type via the control means.

It is true that the pressure conditions at the flue gas chimney change during a malfunction since a draw through the flue gas chimney occurs due to natural convection. This occurs as a consequence of temperature differences over the chimney height and the pressure drop over the chimney due to the proportion of the flow rate of flue gases. In the event of a downstream carbon dioxide separation unit the entirety of the flue gas is passed through the flue gas chimney with the result that the pressure drop over the flue gas chimney is particularly large and the pressure at the flue gas outlet of the flue gas-generating unit is therefore also altered. However, this pressure change is detected only when the malfunction has already occurred. Following the principles of such feed back control this type of control is slow to respond and therefore not optimal.

If pressure control in normal operation does not work properly on account of this slow response the flue gas chimney may further permanently draw ambient air which can reduce the efficiency and/or capacity of the downstream carbon dioxide separation process and/or shorten the service life of the employed absorption media.

### SUMMARY

It is generally therefore an object of the present invention to overcome the aforementioned disadvantages of the prior art.

It is especially an object of the present invention to improve the control of the pressure as the controlled variable in the flue gas-generating unit in such a way that the system can react more quickly to the influence of malfunction variables than would be the case for control via measurement of pressure as the command variable.

These objects are at least partially achieved with the process and the apparatus according to the independent claims. Further advantageous embodiments are specified in the dependent claims. The features presented in the claims and in the description may be combined with one another in any technologically advantageous way.

The terms “having”, “comprising” or “containing” etc. do not preclude the possible presence of further elements, ingredients etc. The indefinite article “a” does not preclude the possible presence of a plurality.

The present invention provides a process for separating carbon dioxide from a flue gas stream, wherein a first unit generates a carbon dioxide-containing flue gas stream in a combustion space and a second unit is configured for separating carbon dioxide from the carbon dioxide-containing flue gas stream, the second unit thus generating a carbon dioxide product stream, and a flue gas chimney having a flue gas inlet and a flue gas outlet is arranged downstream of the first unit and upstream of the second unit, wherein the first unit is connected to the flue gas inlet of the flue gas chimney via a first conduit and the second unit is connected to the flue gas outlet of the flue gas chimney via a second conduit and a pressure-elevating apparatus, in particular a blower, is arranged within the first conduit, wherein the pressure-elevating apparatus is configured for withdrawing flue gas from the first unit and for keeping the pressure in the first unit constant,
characterized in that
a flow rate measurement for determining an actual flue gas flow rate within the first conduit is effected upstream of the flue gas chimney within the first conduit and the pressure in the first unit is controlled using a control unit, wherein the actual flue gas flow rate within the first conduit is used as an input signal for the control unit.

The first unit generates a carbon dioxide-containing flue gas stream in a combustion space. According to an example, the carbon dioxide-containing flue gas stream contains 5 mol % to 90 mol % of carbon dioxide (CO₂) on a wet basis and has a pressure of 0.5 bar and 2 bar absolute, preferably of 0.9 bar and 1.1 bar absolute. The first unit may be any desired unit configured for generating a carbon dioxide-containing flue gas stream. In one example the first unit is a steam reformer. The steam reformer has a combustion space in which catalyst-filled reformer tubes are fired by combustion of a fuel to produce heat and the flue gas stream. In a further example the first unit is a fired heating in which a fuel is burned to produce heat and the flue gas stream, wherein the hot flue gas stream may be utilized for heat transfer in a process or for generating steam.

The pressure to be controlled in the first unit is the controlled variable of the process, in particular of the relevant control loop. The pressure-elevating apparatus, in particular the blower, is configured to keep the pressure in the first unit constant, i.e. to adjust it to a predetermined setpoint. In particular, the pressure-elevating apparatus is configured to keep the pressure within the combustion space of the first unit constant, in particular to adjust it to a predetermined setpoint. The control unit preferably outputs an output signal to the pressure-elevating apparatus which keeps the setpoint of the controlled variable constant, in particular keeps the pressure in the first unit constant, preferably via a manipulated variable.

The second unit is configured for separating carbon dioxide from the carbon dioxide-containing flue gas stream and generates a carbon dioxide product stream. The second unit may be any desired unit for separating carbon dioxide which is suitable for generating a carbon dioxide product stream. The carbon dioxide product stream especially has a higher carbon dioxide concentration than the flue gas stream. In one example, the carbon dioxide product stream comprises a proportion of at least 50 mol % of carbon dioxide on a dry basis, preferably of at least 75 mol % of carbon dioxide, more preferably of at least 95 mol % of carbon dioxide. The carbon dioxide product stream especially comprises a higher proportion of carbon dioxide in mol % on a dry basis than the flue gas stream in mol % on a wet basis.

It is preferable when the second unit is a unit which generates the carbon dioxide product stream from the carbon dioxide-containing flue gas stream by absorption of carbon dioxide in an absorption medium and desorption of carbon dioxide from this absorption medium. Corresponding processes are well known to those skilled in the art. In one example, and preferably, the second unit is a gas scrubbing unit having an absorption column and a desorption column, wherein the absorption medium binds carbon dioxide by chemical means. The gas scrubbing unit is in particular an amine scrubbing unit.

It is further preferable when the second unit is a unit which generates the carbon dioxide product stream from the carbon dioxide-containing flue gas stream by condensation of carbon dioxide from the flue gas stream at low temperatures. Such units are also referred to as cryogenic units. Such a unit may further comprise a distillation apparatus for further purifying the condensed carbon dioxide and one or more membrane apparatuses for separating further concomitant gases.

A flue gas chimney is arranged downstream of the first unit and upstream of the second unit. “Downstream” of the first unit is to be understood as meaning downstream of the first unit in the flow direction of the flue gas stream. “Upstream” of the second unit is to be understood as meaning upstream of the second unit in the flow direction of the flue gas stream.

The first unit is connected to a flue gas inlet of the flue gas chimney via a first conduit. The first conduit is therefore especially arranged between the first unit and the flue gas chimney. The first conduit is in particular a flue gas channel. In one example, such a flue gas channel may have a diameter of more than 1 m or of more than 3 m or of more than 5 m. A plurality of apparatuses, for example measurement and gas transport apparatuses and/or heat exchangers, may be integrated into the first conduit. These apparatuses may therefore form part of the first conduit.

The second unit is connected to a flue gas outlet of the flue gas chimney via a second conduit. The second conduit is therefore especially arranged between the second unit and the flue gas chimney. The second conduit is especially a flue gas channel. In one example, such a flue gas channel may have a diameter of more than 1 m or of more than 3 m or of more than 5 m. A plurality of apparatuses, such as measurement and gas transport apparatuses, may also be integrated into the second conduit. In particular, apparatuses for pretreatment of the flue gas stream may be integrated into the first conduit before the flue gas stream is introduced into the second unit. These apparatuses may therefore form part of the second conduit.

The flue gas chimney is a construction known to those skilled in the art which comprises a substantially vertically arranged flue gas conduit. In the upper region or head region this conduit comprises an opening for discharging flue gases to the environment. The flue gas chimney comprises a flue gas inlet and a flue gas outlet. The flue gas outlet is to be distinguished from the opening in the head region of the flue gas chimney. The flue gas inlet and the flue gas inlet in the context of the invention are preferably arranged in a lower region of the flue gas chimney, preferably arranged within a lower third of the flue gas chimney in respect of the vertical length of the flue gas chimney.

A pressure-elevating apparatus configured for withdrawing flue gas from the first unit and configured or adapted for keeping the pressure in the first unit constant is arranged within the first conduit. The pressure-elevating apparatus is especially adapted for keeping the pressure in the combustion space of the first unit constant. The pressure-elevating apparatus has a suction side and a pressure side. The pressure on the suction side is always lower than the pressure on the pressure side. The pressure-elevating apparatus is preferably a blower. The pressure within the first unit may be kept constant for example by varying the speed of such a blower. The speed of the blower is then a manipulated variable which affects the controlled variable of the process, in particular the pressure in the first unit. If a lot of flue gas is generated in the first unit the pressure in the first unit may be kept constant by a high speed of the blower according to the flue gas amount. If less flue gas is generated the pressure in the first unit may further be kept constant by reducing the speed of the blower.

The terms “arranged within the first conduit” and “arranged within the second conduit” are in a mechanical sense especially to be understood as meaning that the respective conduit is interrupted at the relevant place and the respective element arranged within the respective conduit is connected to the respective conduit via an inlet and an outlet.

According to the invention it is provided that upstream of the flue gas chimney within the first conduit a flow rate measurement for determining an actual flue gas flow rate within the first conduit is effected and the pressure in the first unit is controlled using a control unit, wherein the actual flue gas flow rate within the first conduit is used as an input signal for the control unit.

The actual flue gas flow rate within the first conduit is output to the control unit as an input signal. Especially the actual flue gas flow rate within the first conduit is used as a command variable in the process, in particular as a command variable for the relevant control loop.

The flue gas flow rate may be determined as a volume flow rate, mass flow rate or molar flow rate.

The flow rate measurement to determine the actual flue gas flow rate within the first conduit may be effected upstream or downstream of the pressure-elevating apparatus. The flow rate measurement for determining the actual flue gas flow rate is preferably effected downstream of the pressure-elevating apparatus.

Instead of disadvantageous detection of the pressure as a command variable it is proposed according to the invention to use the actual flue gas flow rate within the first conduit as the command variable and thus as the input signal for the control unit. The use of the actual flue gas flow rate within the first conduit as an input signal for the control unit results in an improved and especially faster control and thus faster keeping constant of the pressure in the first unit, in particular in the case of malfunctions which as a malfunction variable can affect the pressure in the first unit as the controlled variable. On the basis of this input signal the control unit generates an output signal which is especially output to the pressure-elevating apparatus and is thus used in particular as a manipulated variable for controlling the pressure in the first unit. As described above, the manipulated variable may be for example a rotational speed of the pressure-elevating apparatus or the opening angle of a flap element arranged in the first conduit.

The capturing of the actual flue gas flow rate within the first conduit as a command variable has the advantage that the flue gas flow rate may be calculated for various normal and malfunction scenarios of the respective plant. This makes it possible to implement in the system a feed forward control concept which would not be possible on the basis of a pressure measurement as the command variable. Deviations between an expected flue gas flow rate and the actually determined flue gas flow rate can be detected even if a malfunction has not yet led to a significant pressure change in the system.

A preferred embodiment of the process according to the invention is therefore characterized in that the control unit captures at least one influencing variable suitable for predicting a calculable flue gas flow rate, whereby on the basis of the at least one influencing variable a calculated flue gas flow rate at which the flue gas is expected to flow through the first conduit is determined and wherein the calculated flue gas flow rate within the first conduit is compared to the actual flue gas flow rate within the first conduit.

In this embodiment the control unit captures at least one influencing variable, for example via a measurement which is suitable for calculating the flue gas flow rate on the basis of this at least one influencing variable. The at least one influencing variable is preferably a flow rate of a starting material which has a direct influence on the amount of flue gases formed and thus on the flue gas flow rate. It is possible to determine a plurality of influencing variables which are suitable for calculating the flue gas flow rate. To make the calculation of the flue gas flow rate more precise it is also possible to use influencing variables which do not have a direct influence on the amount of flue gases formed. What is decisive is merely that at least one influencing variable suitable for calculating an expected flue gas flow rate is determined.

Examples of influencing variables are
the flow rate of a fuel for flue gas generation, in particular a hydrocarbon-containing fuel;
the composition of a fuel for flue gas generation, in particular the carbon content, the hydrogen content and/or the oxygen content of the fuel;
the flow rate of an oxidant, in particular air, oxygen-enriched air or pure oxygen;
the composition of the oxidant, in particular with respect to the oxygen content of the oxidant;
pressure;
temperature.

The two first-mentioned influencing variables are especially suitable in combination for calculating the expected flue gas flow rate in the first conduit. The prevailing pressure and the prevailing temperature may be used to make the calculation of the flue gas flow rate more precise. The flow rates of the fuel and/or of the oxidant may be determined as a volume flow rate, mass flow rate or molar flow rate. The composition of the fuel and the composition of the oxidant are generally constant since these are provided from a source which provides a constant composition. These variables are therefore generally known and may be incorporated into the calculation as constants.

A preferred embodiment of the process according to the invention is characterized in that by comparison of the calculated flue gas flow rate within the first conduit and the actual flue gas flow rate within the first conduit a flue gas flow rate difference is determined and the determined flue gas flow rate difference is used as an input signal for the control unit.

This embodiment of the process is especially suitable for detecting changes in conditions on account of malfunction variables in the first unit and/or the second unit or in a component between the first and the second unit. If the actually determined flue gas flow rate within the first line deviates from the calculated flue gas flow rate by more than a predefined permitted variation the control unit can react immediately, in particular before the malfunction becomes noticeable as a pressure difference in the first conduit due to the influence of the respective malfunction variable.

A preferred embodiment of the process according to the invention is characterized in that the generation of the flue gas in the combustion space of the first unit is effected by combustion of a hydrocarbon-containing input material with an oxygen-containing oxidant via at least one burner and the influencing variable is the flow rate of oxidant supplied to the at least one burner and/or the influencing variable is the flow rate of hydrocarbon-containing input material supplied to the at least one burner.

The “and” option is preferred. One or more burners may be arranged in the combustion space of the flue gas-generating unit. Multiple burners are preferred. In each case the control unit captures as an influencing variable the total amount, i.e. the total flow rate, of hydrocarbon-containing input material and/or of oxidant which is supplied to the burner or the burners. As described above the composition of the fuel and of the oxidant in this context can often be assumed to be constant.

A preferred embodiment of the process according to the invention is characterized in that the hydrocarbon-containing input material is a fuel gas, in particular natural gas, and/or the hydrocarbon-containing input material is an offgas from a pressure swing adsorption unit.

If the first unit is a steam reformer with a downstream water gas shift reactor the corresponding plant generally comprises a pressure swing adsorption unit which generates high purity hydrogen and an offgas. The offgas contains not only carbon dioxide but generally also methane and carbon monoxide. Both gases may be utilized as fuel for the combustion in the fuel space of the first unit.

A preferred embodiment of the process according to the invention is characterized in that downstream of the flue gas chimney within the second conduit a flow rate measurement for determining an actual flue gas flow rate within the second conduit is effected and the actual flue gas flow rate within the second conduit is used as an input signal for the control unit.

In this embodiment too an actual flue gas flow rate is determined within the second conduit and thus downstream of the flue gas chimney. The actual flue gas flow rate within the second conduit may also be determined as a volume flow rate, mass flow rate or molar flow rate. The actual flue gas flow rate within the second conduit may be output to the control unit as a further input signal. The actual flue gas flow rate within the second conduit is thus a further command variable for the process, in particular the relevant control loop. Control of the process may be further improved especially when a further pressure-elevating apparatus, in particular a blower, is arranged within the second conduit, i.e. downstream of the flue gas chimney and upstream of the second unit. The pressure-elevating apparatus upstream of the flue gas chimney and the further pressure-elevating apparatus downstream of the flue gas chimney may then be adapted to one another such that the flue gas flow rate within the flue gas chimney is minimized. The expression “flue gas flow rate within the flue gas chimney” is to be understood as meaning the amount of flue gases escaping into the atmosphere through the flue gas chimney. If a flue gas flow rate is also determined within the second conduit and if a further pressure-elevating apparatus is present then the determination of the flue gas flow rate within the second conduit is preferably effected upstream of the further pressure-elevating apparatus and downstream of the flue gas chimney. In a preferred embodiment a further pressure-elevating apparatus, in particular a blower, is arranged within the second conduit.

Accordingly a preferred embodiment of the process is characterized in that the actual flue gas flow rate within the flue gas chimney is determined on the basis of the difference between the actual flue gas flow rate within the first conduit and the actual flue gas flow rate within the second conduit and the actual flue gas flow rate within the flue gas chimney is used as an input signal for the control unit.

Control can be further improved when the actual flue gas flow rate within the flue gas chimney is also output as an output signal to the control unit. The actual flue gas flow rate within the flue gas chimney is then determined as a further command variable for the process, in particular for the relevant control loop. As described above this flue gas flow rate within the flue gas chimney is determined indirectly by difference calculation.

A preferred embodiment of the process according to the invention is characterized in that a flue gas scrubber for removing sulfur oxides (SOₓ) from the flue gas stream and for cooling the flue gas stream is arranged within the second conduit and upstream of the second unit and wherein the flow rate measurement for determining the actual flue gas flow rate within the second conduit is effected upstream of the flue gas scrubber.

In this embodiment the flow rate measurement within the second conduit is effected upstream of the flue gas scrubber. The flue gas scrubber is used for pre-treatment of the flue gases before these are introduced into the second unit for carbon dioxide separation. The flue gas scrubber is especially used for cooling the flue gas stream and for removing sulfur dioxide from the flue gas stream. A certain amount of water is generally also removed from the flue gas stream by condensation. The flue gas streams within the second conduit upstream of the flue gas scrubber and upstream of the flue gas chimney are therefore comparable in terms of their composition, pressure and temperature. It is therefore advantageous to undertake determination of the flow rate of the flue gas stream within the second conduit upstream of the flue gas scrubber. A false, i.e. non-representative, value would otherwise result particularly in respect of the indirect determination of the flue gas flow rate within the flue gas chimney.

If a further pressure-elevating apparatus, in particular a blower, is present within the second conduit this is preferably arranged downstream of the flue gas scrubber and upstream of the second unit.

A preferred embodiment of the process according to the invention is characterized in that the pressure-elevating apparatus, in particular the blower, comprises a rotating element and the control unit controls the pressure in the first unit through the speed of the rotating element via an output signal.

It is preferable when the flue gas flow rate within the first conduit is controlled via the speed of the rotating element, wherein the speed is a manipulated variable of the process, in particular of the relevant control loop. This manipulated variable is determined by the output signal from the control unit which results from one or more input signals to the control unit. By changing the speed of the rotating element of the pressure-elevating apparatus the pressure as the controlled variable is thus kept constant within the first unit when the conditions of the process change, in particular the influence of a malfunction variable results in a change in the conditions.

It may further be provided that a flap element having an alterable flow cross section is arranged within the first conduit and the control unit additionally controls the pressure in the first unit through the magnitude of the flow cross section of the flap element via an output signal.

The control unit can additionally control the pressure in the first unit using a further output signal by means of which the magnitude of the flow cross section of a flap element is altered. The magnitude of the flow cross section of the flap element may be considered as a manipulated variable of the process, in particular of the relevant control loop, similarly to the speed of the pressure-elevating apparatus. The flap element may be any flap element known to those skilled in the art. What is decisive is merely that the magnitude of the flow cross section of the flap element is alterable, i.e. may be made larger and smaller. This changes the flow cross section within the first conduit. Examples of flap elements include shutoff flaps, double flaps, louvre flaps, pivoting flaps and sliders.

It may also be provided that the second conduit too has arranged within it a flap element having an alterable flow cross section by means of which the pressure in the first unit is accordingly controlled.

A preferred embodiment of the process according to the invention is characterized in that a measurement of the oxygen concentration in the flue gas stream is effected within the first conduit and/or within the second conduit and the determined oxygen concentration is used as an input signal for the control unit.

The oxygen concentration can thus serve as a further command variable for controlling the process.

It is preferable when the measurement of the oxygen concentration is effected within the second conduit upstream of the second unit.

Measuring the oxygen concentration in the flue gas stream further makes it possible to improve the quality of control, in particular with respect to the determination of malfunction variables. If for example the oxygen concentration in the flue gas stream increases sharply this may be a pointer to an insufficient supply of fuel. This can also mean that infiltrated air enters into the system through the flue gas chimney and can thus pass into the second unit. An excessive oxygen concentration in the flue gas is in principle a problem for the second unit since oxygen is firstly difficult to separate and can secondly lead to performance losses in the second unit, in particular when using an amine scrub. Detection of the oxygen concentration in the flue gas stream is therefore particularly suitable for defining alarm scenarios and for detecting fundamental problems during ongoing operation.

The invention further provides an apparatus for separating carbon dioxide from a flue gas stream comprising
a first unit which generates a carbon dioxide-containing flue gas stream in a combustion space;
a second unit configured for separating carbon dioxide from the carbon dioxide-containing flue gas stream and thus producing a carbon dioxide product stream;
a flue gas chimney which is arranged downstream of the first unit and upstream of the second unit, wherein the flue gas chimney has a flue gas inlet and a flue gas outlet and the flue gas chimney is connected to the first unit via the flue gas inlet via a first conduit and is connected to the second unit via the flue gas outlet via a second conduit;
a pressure-elevating apparatus, in particular a blower, which is arranged within the first conduit and is configured for withdrawing flue gas from the first unit and for keeping the pressure in the first unit constant,
characterized in that
a flow rate measurement apparatus is arranged within the first conduit, wherein the flow rate measurement apparatus is adapted for determining an actual flue gas flow rate within the first conduit and the pressure in the first unit may be controlled using a control unit, wherein the actual flue gas flow rate within the first conduit may be used as an input signal for the control unit.

A preferred embodiment of the apparatus according to the invention is characterized in that the control unit makes it possible to capture at least one influencing variable suitable for predicting a calculable flue gas flow rate, whereby on the basis of the at least one influencing variable a calculated flue gas flow rate at which the flue gas is expected to flow through the first conduit may be determined and wherein the calculated flue gas flow rate within the first conduit may be compared to the actual flue gas flow rate within the first conduit.

A preferred embodiment of the apparatus according to the invention is characterized in that by comparison of the calculated flue gas flow rate within the first conduit and the actual flue gas flow rate within the first conduit a flue gas flow rate difference may be determined and the determined flue gas flow rate difference may be used as an input signal for the control unit.

A preferred embodiment of the apparatus according to the invention is characterized in that the first unit comprises in the combustion space at least one burner which generates the flue gas stream by combustion of a hydrocarbon-containing input material with an oxygen-containing oxidant and the influencing variable is the flow rate of oxidant supplied to the at least one burner and/or the influencing variable is the flow rate of hydrocarbon-containing input material supplied to the at least one burner.

A preferred embodiment of the apparatus according to the invention is characterized in that the hydrocarbon-containing input material is a fuel gas, in particular natural gas, and/or the hydrocarbon-containing input material is an offgas from a pressure swing adsorption unit.

A preferred embodiment of the apparatus according to the invention is characterized in that downstream of the flue gas chimney within the second conduit a flow rate measurement apparatus for determining an actual flue gas flow rate within the second conduit is arranged and the actual flue gas flow rate within the second conduit may be used as an input signal for the control unit.

A preferred embodiment of the apparatus according to the invention is characterized in that the actual flue gas flow rate within the flue gas chimney may be determined on the basis of the difference between the actual flue gas flow rate within the first conduit and the actual flue gas flow rate within the second conduit and the actual flue gas flow rate within the flue gas chimney may be used as an input signal for the control unit.

A preferred embodiment of the apparatus according to the invention is characterized in that a flue gas scrubber for removing sulfur oxides (SOₓ) from the flue gas stream and for cooling the flue gas stream is arranged within the second conduit and upstream of the second unit and wherein the flow rate measurement apparatus for determining the actual flue gas flow rate within the second conduit is arranged upstream of the flue gas scrubber.

A preferred embodiment of the apparatus according to the invention is characterized in that the pressure-elevating apparatus, in particular the blower, comprises a rotating element and the control unit controls the pressure in the first unit through the speed of the rotating element via an output signal.

A preferred embodiment of the apparatus according to the invention is characterized in that a flap element having an alterable flow cross section is arranged within the first conduit and the control unit additionally controls the pressure in the first unit through the magnitude of the flow cross section of the flap element via an output signal.

A preferred embodiment of the apparatus according to the invention is characterized in that a measurement apparatus for determining the oxygen concentration in the flue gas stream is arranged within the first conduit and/or within the second conduit and the determined oxygen concentration may be used as an input signal for the control unit.

### Brief Description of the Drawing

The invention will now be more particularly elucidated with reference to a FIGURE. FIG. 1 shows a particularly preferred exemplary embodiment but the invention is not limited thereto. The FIGURE and the proportions shown therein are only schematic and not to scale. In the figures:

FIG. 1 shows an apparatus according to the invention for separation of carbon dioxide which is suitable for performing the process according to the invention.

### DETAILED DESCRIPTION OF THE PREFERRED EMBODIMENTS

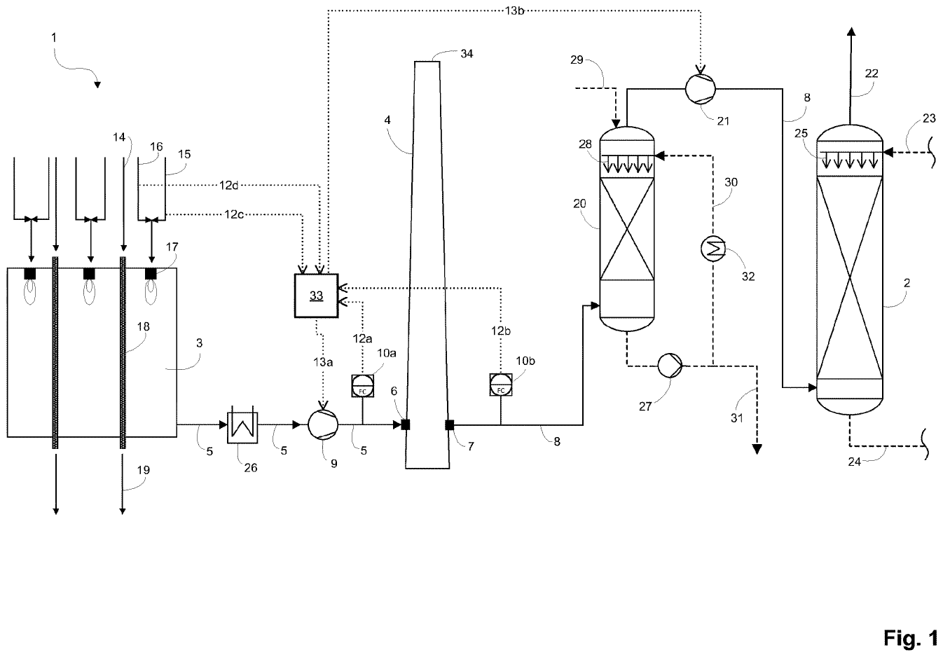

FIG. 1 shows an arrangement according to the invention comprising a first unit 1, a second unit 2 and a flue gas chimney 4. The flue gas chimney 4 is connected to the first unit 1 via a first conduit 5 via a flue gas inlet 6. The flue gas chimney 4 is further connected to the second unit 2 via a second conduit 8 via a flue gas outlet 7.

The first unit 1 is configured as a steam reformer and has a combustion space 3 in which a plurality of burners 17 generate a flue gas which is withdrawn from the combustion space 3 of the first unit 1 using a pressure-elevating apparatus 9. The steam reformer comprises a plurality of catalyst-filled reformer tubes 18 in which a natural gas-steam mixture from a conduit 14 is converted into a synthesis gas mixture which is withdrawn from the steam reformer via a plurality of conduits 19 and is subjected to a further workup (not shown). Due to the endothermicity of the steam reforming reaction the reformer tubes 19 are fired via the plurality of burners 17 arranged at the top of the combustion space. The burners 17 are supplied with fuel and with an oxidant, for example air, via the conduits 15 and 16. The combustion chamber 3 of the first unit 1 may also be referred to as the radiation zone of the steam reformer. The flue gas stream generated by the burners 17 is withdrawn from the combustion space 3 via the first conduit 5. A thermal recovery apparatus 26 is arranged within the first conduit 5. Even if only shown as a single heat exchanger the thermal recovery apparatus 26 may comprise a string of heat exchangers. The thermal recovery apparatus 26 serves to cool the flue gas stream and simultaneously heat other media, for example for production of steam.

The flue gas chimney 4 is openly integrated into the arrangement, i.e. in ongoing operation of the arrangement there is always contact with the environment via an opening 34 in the top region of the flue gas chimney 4. The flue gas chimney 4 is integrated into the arrangement downstream of the first unit 1 and upstream of the second unit 2.

The first conduit 5 and the second conduit 8 are at least in sections configured as a flue gas channel. The thermal recovery apparatus 26 and the pressure-elevating apparatus 9, configured as a blower, are arranged within the first conduit and fluidically connected thereto. A flue gas scrubber 20 and a further pressure-elevating apparatus 21, likewise configured as a blower, are arranged within the second conduit 8 and fluidly connected thereto.

The second unit 2 is only partially shown in FIG. 1. The second unit 2 is adapted for separation of the carbon dioxide from the flue gas stream, the latter being introduced into the second unit 2 via the second conduit 8. To this end the second unit 2 has an absorption column for chemical absorption of carbon dioxide over a chemical absorbent and a desorption column for desorption of carbon dioxide from the absorbent (not shown). As absorption medium a regenerated amine solution, i.e. an amine solution freed of carbon dioxide, is introduced into the second unit 2 via a conduit 23. The absorption medium 25 is run from top to bottom while the flue gas to be purified flows from bottom to top. The flue gas freed of carbon dioxide is withdrawn from the second unit 2 via a conduit 22. Carbon dioxide-laden absorption medium is withdrawn from the second unit 2 via conduit 24 and supplied to the desorption column (not shown) in which the laden amine solution is freed of carbon dioxide by introduction of steam. The carbon dioxide stream thus generated is withdrawn from the desorption column and sent for further processing (drying, fine purification, compression) (not shown). The resulting carbon dioxide stream may subsequently be sequestered as a carbon dioxide product stream or sent for further use, for example as a feedstock for methanol synthesis.

The flue gas scrubber 20 arranged within the second conduit 8 is used for pretreatment of the flue gas stream before this is introduced into the second unit 2 for absorption of carbon dioxide. The flue gas scrubber 20 is especially used for further cooling of the flue gas stream and for removing sulfur oxides (SO_{X}) using an aqueous scrubbing medium 28. The scrubbing medium 28 is circulated through the flue gas scrubber using a recirculation pump 27 and conduit 30 and continuously cooled via a heat exchanger 32. For regeneration of the scrubbing medium a portion of the circulating scrubbing medium is constantly withdrawn via a conduit 31 and a corresponding portion of fresh scrubbing medium supplied to the flue gas scrubber 20 via a conduit 29.

The pressure-elevating apparatus 9 is used to keep the pressure in the combustion space 3 of the first unit 1 constant. As mentioned above the first pressure-elevating apparatus 9 is configured as a blower. The pressure may be kept constant by controlling the speed of the blower 9. To this end a flow rate measurement 10a is effected downstream of the blower 9 and upstream of the flue gas chimney 4 to determine the flow rate of the flue gas stream at this point. This actual flue gas flow rate within the first conduit 5 is output as an input signal 12a to a control unit 33 via a signal conduit. The flow rates of the fuel in fuel conduit 15 and of the oxidant in oxidant conduit 16 are further output to the control unit as an input signal 12c/an input signal 12d via signal lines. From the input signals 12c and 12d the control unit 33 determines a calculated flue gas flow rate derived from the flow rates of fuel and oxidant and the known compositions of the fuel (in particular carbon and hydrogen content) and of the oxidant (in particular oxygen content). The control unit 33 can compare this calculated flue gas flow rate with the flue gas flow rate actually determined by the flow rate measurement 10a. Under stable operating conditions the absolute values for these two determined flue gas flow rates should be approximately equal. As soon as a difference between the calculated and actually prevailing value that exceeds a predefined maximum value is determined it is possible to assume a malfunction in the system, to which the control unit 33 can immediately react due to the principle of this feed forward control.

The control of the arrangement can be further improved when a flow rate measurement 10b for determining the actual flue gas flow rate within the second conduit downstream of the flue gas chimney 4 is also effected downstream of the flue gas chimney within the second conduit 8. The flue gas flow rate through the flue gas chimney 4 can thus be determined by calculating the difference between the actual flue gas flow rate within the first conduit 5 and the second conduit 8. This should ideally be controlled via the blower and optionally a further element (for example a flap element) such that it has a magnitude of “zero”. The actual flue gas flow rate within the second conduit 8 is output as input signal 12b to the control unit 33 via a signal conduit. The control of the pressure-elevating apparatus 9 can be further optimized on the basis of the information of the actual flue gas flow rates in the first conduit 5, in the second conduit 8, and the calculated flue gas flow rate. This is effected via an output signal 13a of the control unit 33 which is output to the pressure-elevating apparatus 9 via a signal conduit. The output signal is calculated by the control unit 33 on the basis of at least one signal of the input signals 12a, 12b, 12c and 12d. The control of the arrangement may be further improved by the control unit 33 further outputting an output signal 13b to the further pressure-elevating apparatus 21 via a signal conduit. This can especially optimize the control with respect to minimizing the actual flue gas flow rate through the flue gas chimney 4 since greater account is taken of the interaction between the two pressure-elevating apparatuses 9 and 21.

### LIST OF REFERENCE NUMERALS

1 First unit (steam reformer)
2 Second unit (partial)
3 Combustion space
4 Flue gas chimney
5 First conduit (flue gas conduit)
6 Flue gas inlet
7 Flue gas outlet
8 Second conduit (flue gas conduit)
9 Pressure-elevating apparatus (blower)
10a, 10b Flow rate measurement
11 Control unit
12a, 12b, 12c, 12d Input signal
13a, 13b Output signal
14 Natural gas steam conduit
15 Fuel conduit
16 Oxidant conduit
17 Burner
18 Reformer tube
19 Synthesis gas conduit
20 Flue gas scrubber
21 Pressure-elevating apparatus (blower)
22 Flue gas conduit (for purified flue gas)
23 Conduit for absorption medium (regenerated)
24 Conduit for absorption medium (laden)
25 Absorption medium
26 Thermal recovery apparatus
27 Recirculation pump
28 Scrubbing medium
29 Conduit (for fresh scrubbing medium)
30 Conduit (for circulating scrubbing medium)
31 Conduit (for used washing medium)
32 Heat exchanger
33 Control unit
34 Flue gas chimney opening

1.-22. (canceled)

23: A process for separating carbon dioxide from a flue gas stream, comprising:
generating in a first unit a carbon dioxide-containing flue gas in a combustion space,
separating in a second unit carbon dioxide from the carbon dioxide-containing flue gas stream, the second unit thus generating a carbon dioxide product stream, and
locating a flue gas chimney having a flue gas inlet and a flue gas outlet downstream of the first unit and upstream of the second unit,
wherein
the first unit is connected to the flue gas inlet of the flue gas chimney via a first conduit and the second unit is connected to the flue gas outlet of the flue gas chimney via a second conduit
a pressure-elevating apparatus is arranged within the first conduit, wherein the pressure-elevating apparatus is configured for withdrawing flue gas from the first unit and for keeping the pressure in the first unit constant,
a flow rate measurement for determining an actual flue gas flow rate within the first conduit is effected upstream of the flue gas chimney within the first conduit and the pressure in the first unit is controlled using a control unit, and
the actual flue gas flow rate within the first conduit is used as an input signal for the control unit.

24: The process according to claim 23, wherein the control unit captures at least one influencing variable suitable for predicting a calculable flue gas flow rate,
whereby on the basis of the at least one influencing variable a calculated flue gas flow rate at which the flue gas is expected to flow through the first conduit is determined and
wherein the calculated flue gas flow rate within the first conduit is compared to the actual flue gas flow rate within the first conduit.

25: The process according to claim 24, wherein by comparison of the calculated flue gas flow rate within the first conduit and the actual flue gas flow rate within the first conduit a flue gas flow rate difference is determined and the determined flue gas flow rate difference is used as an input signal for the control unit.

26: The process according to claim 24, wherein the generation of the flue gas in the combustion space of the first unit is effected by combustion of a hydrocarbon-containing input material with an oxygen-containing oxidant via at least one burner and the influencing variable is the flow rate of oxidant supplied to the at least one burner and/or the influencing variable is the flow rate of hydrocarbon-containing input material supplied to the at least one burner.

27: The process according to claim 26, wherein the hydrocarbon-containing input material is a fuel gas and/or the hydrocarbon-containing input material is an offgas from a pressure swing adsorption unit.

28: The process according to claim 23, wherein downstream of the flue gas chimney, within the second conduit, a flow rate measurement for determining an actual flue gas flow rate within the second conduit is effected and the actual flue gas flow rate within the second conduit is used as an input signal for the control unit.

29: The process according to claim 28, wherein the actual flue gas flow rate within the flue gas chimney is determined on the basis of the difference between the actual flue gas flow rate within the first conduit and the actual flue gas flow rate within the second conduit and the actual flue gas flow rate within the flue gas chimney is used as an input signal for the control unit.

30: The process according to claim 28, wherein a flue gas scrubber for removing sulfur oxides from the flue gas stream and for cooling the flue gas stream is arranged within the second conduit and upstream of the second unit and wherein the flow rate measurement for determining the actual flue gas flow rate within the second conduit is effected upstream of the flue gas scrubber.

31: The process according to claim 23, wherein the pressure-elevating apparatus comprises a rotating element and the control unit controls the pressure in the first unit through the speed of the rotating element via an output signal.

32: The process according to claim 31, wherein a flap element having an alterable flow cross section is arranged within the first conduit and the control unit additionally controls the pressure in the first unit through the magnitude of the flow cross section of the flap element via an output signal.

33: The process according to claim 23, wherein a measurement of the oxygen concentration in the flue gas stream is effected within the first conduit and/or within the second conduit and the determined oxygen concentration is used as an input signal for the control unit.

34: An apparatus for separating carbon dioxide from a flue gas stream, comprising
a first unit configured to generate a carbon dioxide-containing flue gas stream in a combustion space;
a second unit configured for separating carbon dioxide from the carbon dioxide-containing flue gas stream and thus producing a carbon dioxide product stream;
a flue gas chimney which is arranged downstream of the first unit and upstream of the second unit, wherein the flue gas chimney has a flue gas inlet and a flue gas outlet and the flue gas chimney is connected to the first unit via the flue gas inlet via a first conduit and is connected to the second unit via the flue gas outlet via a second conduit;
a pressure-elevating apparatus which is arranged within the first conduit and is configured for withdrawing flue gas from the first unit and for keeping the pressure in the first unit constant,
wherein
a flow rate measurement apparatus is arranged within the first conduit,
the flow rate measurement apparatus is adapted for determining an actual flue gas flow rate within the first conduit and the pressure in the first unit may be controlled using a control unit, and
the actual flue gas flow rate within the first conduit may be used as an input signal for the control unit.

35: The apparatus according to claim 34, wherein the control unit enables the capture of at least one influencing variable suitable for predicting a calculable flue gas flow rate,
whereby on the basis of the at least one influencing variable a calculated flue gas flow rate at which the flue gas is expected to flow through the first conduit may be determined and
wherein the calculated flue gas flow rate within the first conduit may be compared to the actual flue gas flow rate within the first conduit.

36: The apparatus according to claim 35, wherein by comparison of the calculated flue gas flow rate within the first conduit and the actual flue gas flow rate within the first conduit a flue gas flow rate difference may be determined and the determined flue gas flow rate difference may be used as an input signal for the control unit.

37: The apparatus according to claim 34, wherein the first unit comprises in the combustion space at least one burner which generates the flue gas stream by combustion of a hydrocarbon-containing input material with an oxygen-containing oxidant and the influencing variable is the flow rate of oxidant supplied to the at least one burner and/or the influencing variable is the flow rate of hydrocarbon-containing input material supplied to the at least one burner.

38: The apparatus according to claim 34, wherein the hydrocarbon-containing input material is a fuel gas and/or the hydrocarbon-containing input material is an offgas from a pressure swing adsorption unit.

39: The apparatus according to claim 34, wherein downstream of the flue gas chimney within the second conduit a flow rate measurement apparatus for determining an actual flue gas flow rate within the second conduit is arranged and the actual flue gas flow rate within the second conduit may be used as an input signal for the control unit.

40: The apparatus according to claim 39, wherein the actual flue gas flow rate within the flue gas chimney may be determined on the basis of the difference between the actual flue gas flow rate within the first conduit and the actual flue gas flow rate within the second conduit and the actual flue gas flow rate within the flue gas chimney may be used as an input signal for the control unit.

41: The apparatus according to claim 39, wherein a flue gas scrubber for removing sulfur oxides (SOₓ) from the flue gas stream and for cooling the flue gas stream is arranged within the second conduit and upstream of the second unit and wherein the flow rate measurement apparatus for determining the actual flue gas flow rate within the second conduit (8) is arranged upstream of the flue gas scrubber.

42: The apparatus according to claim 34, wherein the pressure-elevating apparatus comprises a rotating element and the control unit controls the pressure in the first unit through the speed of the rotating element via an output signal.
